(19) United States
(12) Patent Application Publication
(10) Pub. No.: US 2002/0069597 A1
(43) Pub. Date: Jun. 13, 2002

(54) Window scoop

(76) Inventor: David Lee Van Gorder, Woodbine, GA (US)

Correspondence Address: DAVE VAN GORDER, 11 RETREAT PLACE, WOODBINE, GA, 31569, US

(21) Appl. No.: 09/732,101

(22) Filed: Dec. 7, 2000

(51) Int. Cl. E06B 1/04

(52) U.S. Cl. 52/204.1; 52/202; 52/204.53

(57) ABSTRACT

The window scoop is an item that when properly installed on an exterior window will eliminate rain from coming in the house, eliminate pollen and air contaminants, will detour burglar's from breaking in your property, will save on electric bill. Will protect house in severe weather conditions. Will deaden sound from outside sources. Once installed needs no maintenance.

The following is a complete description of my invention for protecting a residence from water damage, intruders, contaminated air pollutants and acoustical sound deadening characteristics. In an effort to protect our residence, I utilized sheets of Lexan and fashioned it in a way that when attached to the surface of a window it would repel water from coming in the house, would detour intrusion by theft and would reduce pollen, and air pollution. While this product has been on our residence it was noted that this also reduces road traffic noises by approximately 50% or more. Also, while having a energy audit on our house it was verified by our electric company that a clear application of this over our existing windows reduced inside temperature by 5 degrees. If a tinted sheet was used it would have reduced by approximately 10-15 degrees.

To construct this attachment to an outside window, a person needs to measure their existing window opening where the screen is removed for cleaning, this will be the surface that the window scoop will attach to. After the measurement of the height and width of the window has been obtained a ¼″ thick piece of Lexan cut to the width and height of the window opening where the screen is on the bottom half of the window, this will be chemically attached to two triangle shaped sides creating a flat surface with two 90 degree ends with a product called “IPS WELD-ON 4”. This will create a triangle shaped object with a 4″ width opening at the bottom to which the air will enter the house. After the object has been chemically glued at the edges a 1/16″×¾″×¾″ aluminum angle will be secured to the Lexan side pieces using ⅜″ Pan Head bolts with nuts along the edge spaced every 6″ and later attached to the outside surface of the window opening. By using ⅜″ self taping screws which will be secured on top of the aluminum angle spaced approximately every 4″ on the outside of the window frame vertically the window scoop will now be secured to the existing window opening frame. Next a bead of GE Clear Silicone will be applied to the top edges of the window scoop between the existing window frame and the new ¼″ Lexan in a horizontal manner, as to seal the top edge from water penetration. After applying this object to the outside of the window, the resident can rest assured that by leaving the windows opened no water will damage the inside of the house, the product is un-breakable as specified by the manufacturer of Lexan. It will reduce air pollution due to the fact that there is a opening of only 4″×approximately 30″ depending on the width of the window to which fresh air can now enter the house.

Do to the fact that the sound waves from outside noises such as; road traffic, etc. is deflected by the angle of the window scoop, sound is reduced drastically and therefore, quiets the residence while producing a burglar proof atmosphere along with reduced electric cost and reducing the amount of direct forced air into the residence.

### BACKGROUND OF THE INVENTION

As being a licensed General Contractor in the state of Florida, it has been my long time goal to create a product that would reduce electric costs, promote an energy efficient home along with providing a secure environment to which people can rest assured that their residency will not be broken into. I have worked on this product design for approximately two years and have within the last year come up with this application with using ¼″ Lexan which is according to the manufactures specifications, un-breakable, is 250 times stronger than plate glass, can easily cut to size, can be chemically bonded, transmits up to 88% visible light, stain resistant and non-toxic. Is transparent when looking at a window, can't be detected as being applied to a window except for slight deflection of light do to the angle of the window scoop itself By applying this product to windows, not only can the resident leave his home un-attended, but can rest assured that everything possible has been done to detour water damage, burglar protection, severe storm damage, along with reduced energy cost.

### BRIEF SUMMARY OF INVENTION

The general idea of this invention is to provide a simple yet useful device that the average homeowner or property owner to include apartment buildings, condo's etc. can install on his existing windows to provide complete protection from the elements without the use of electric storm shutters, electric burglar protection, provide energy efficient way of leaving the windows open and getting fresh air into a residency without the added inconvenience of dirt and pollutants being blown into the house by leaving the windows opened. This product can be installed in less than 5 minutes on any window, and can be left on indefinitely.

Also, the end of the aluminum angle is tapered to match the end where the triangular shaped ends of the scoop go from 4″ to nothing at the top.

FIG. 6. (Page 3) this is a perspective view of the aluminum angle that is used to secure not only the Lexan window scoop but also for securing it to the existing window frame.

### BRIEF DESCRIPTION OF THE DRAWINGS

For a fuller understanding of the present invention, reference should now be made to the following detailed description thereof taken in conjunction with the accompanying drawings wherein:

FIG. 1 shows a frontal view of the Lexan sheet as it will be applied to the bottom half of a window opening thus going over the area where the screen is and will be left in place in the assembly of the window scoop. Also, shows a front view of the aluminum angle as it will be attached to the window frame.

FIG. 2 is a side view of the entire window in an exterior wall with the window scoop attached to the bottom half of the window screen area, showing the 4″×30″ air space as it will be used to repel water from coming in the inside of the house, also shows the window in open position to allow for ventilation.

FIG. 3 (Page 2) shows a perspective view of the window scoop as it will be attached to the outside of a window frame. Shows position of the aluminum angle support as it will be attached vertically on the existing window frame. Also, shows the horizontal sealing at the top of the window scoop with GE Clear Silicone, to prevent water from seeping in between the ¼″ Lexan and the existing window frame.

FIG. 4 (Page 3) shows a bottom view of the window scoop in place along with a perspective view of the aluminum angle placement on the sides of the two triangular shaped end pieces of the window scoop, also shows approximate width and length of the scoop as it is installed, length measurements will vary with the different types of window sizes.

FIG. 5 (Page 3) shows a typical aluminum angle with the bottom and side screw or bolt designations and approximate spacing depending on height of window, spacing of ⅜″ self taping screws should be between 4″ and 6″ respectively. Also, the use of ⅜″ pan head bolts and nuts to secure the Lexan ends to the angle, this should be done with holes spaced random in between the 4″ and 6″ spacing of the ⅜″ taping screws.

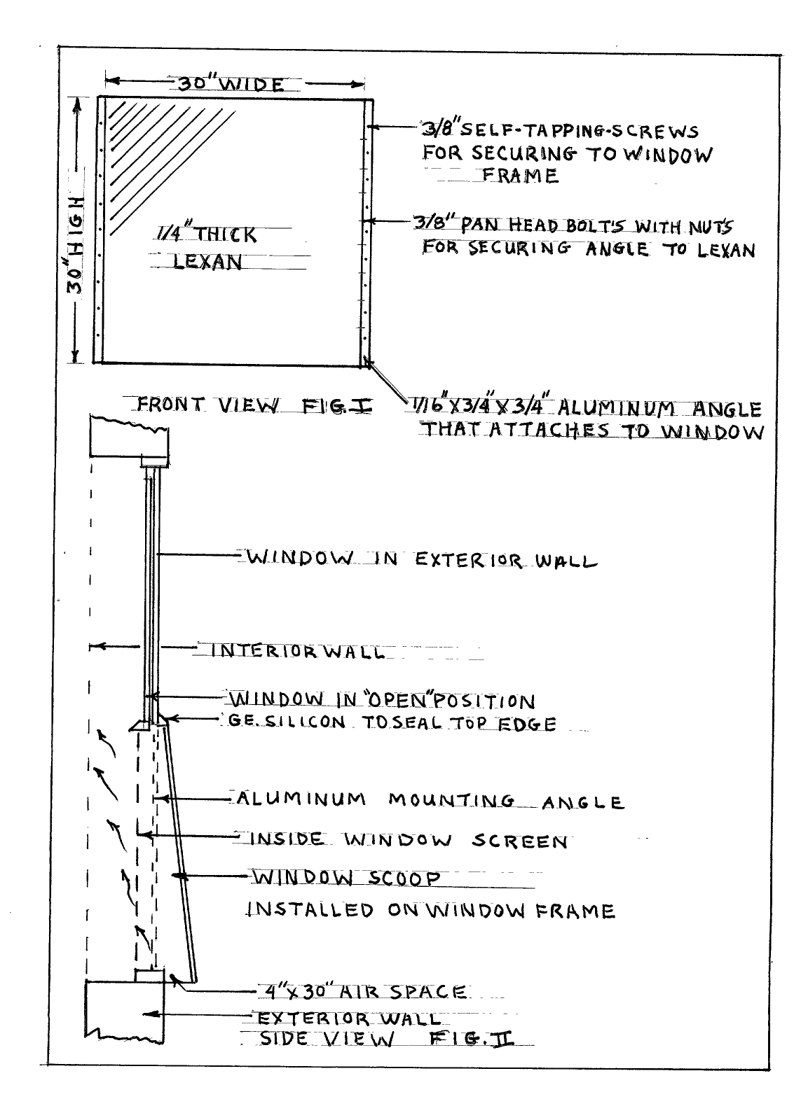

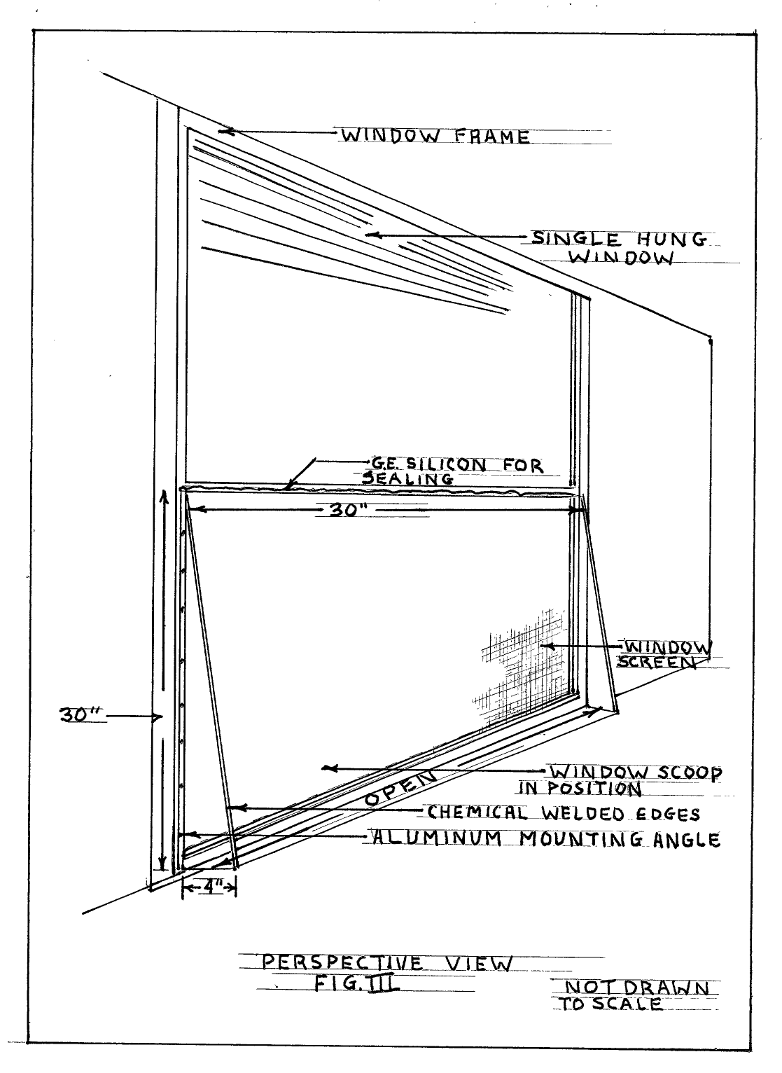

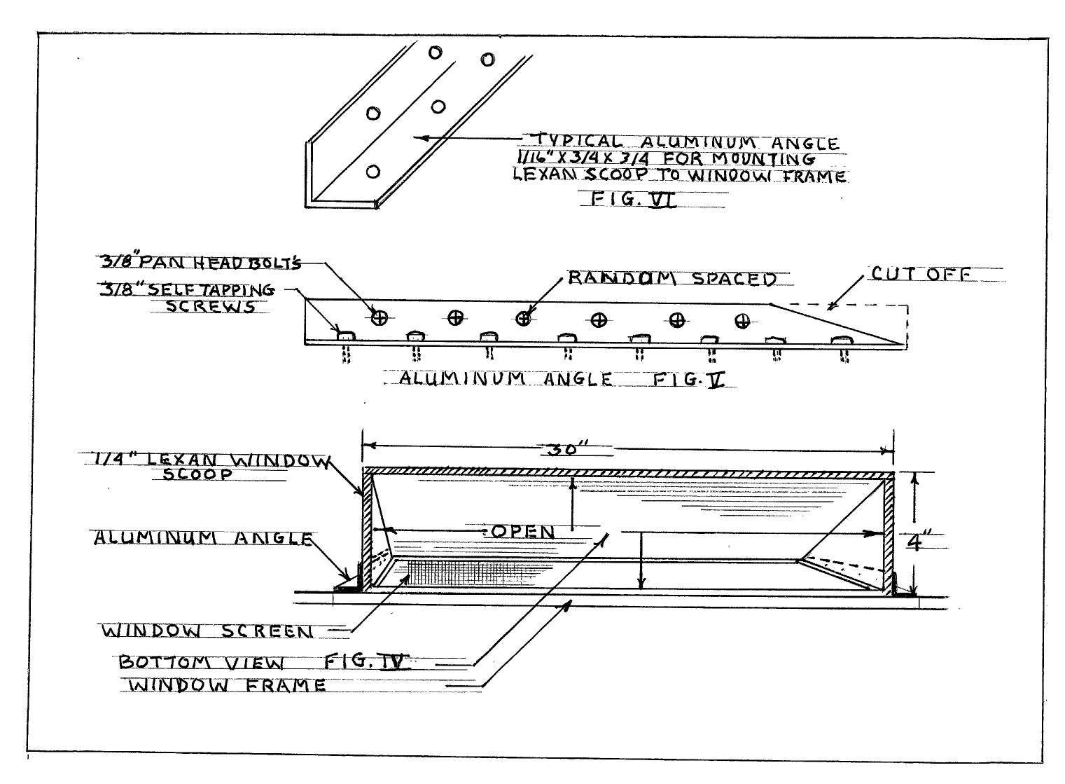

### DETAILED DESCRIPTION OF THE INVENTION

A person making this product from scratch must first measure ¼″ past the edge of the window frame both horizontally and vertically to obtain a size that will cover that area of the window where the screen goes, and allowing enough space to screw the aluminum angle onto the frame without damaging the screen removal area. After this measurement has been determined a ¼″ piece of Lexan is laid flat on a secure surface, the side pieces are cut from 4″ to nothing, and these are then stood up on end as to create a 90 degree angle from the flat sheet on both ends. With IPS WELD ON #4 CHEMICAL WELD, a Q-tip is dipped into the liquid and is evenly applied to the two contact surfaces as mentioned above, and clamped temporarily until the welding has set. Which takes approximately 5 minutes. As soon as the welding has been completed the object is than flipped over so that the flat side is on top of the surface, used for assembly. Then the aluminum side angles are attached to the Lexan sides by drilling holes 1/16″ bigger than the diameter of the ⅜″ pan head bolts. Next the bolts are inserted into these holes and nuts on the inside are hand tightened at this point. The window scoop is then taken to the location of the exterior window and the 4″ thick bottom part of the window scoop is held even with the bottom of the window sill and raised in a vertical position and then is secured to the window frame by the use of the ⅜″ self taping screws. Attention is given to the centering of the window scoop to leave a reveal the same on both sides of the opening as not to screw into the area where the window screen can be removed if needed. After attaching the self taping screws which are spaced approximately 4″ to 6″ apart, GE Clear Silicone is then applied to the top edge where the Lexan top edge and the existing window frame make contact.

What I claim as my invention is:

1. By using an already manufactured product by the name of Lexan I have developed a product that when constructed in a shape of a triangle is the only shape that can be attached to the exterior of a window frame to provide strength without obstructing air flow.

2. When installed on the exterior of an existing window, I have created something that can be used by the average homeowner or property owner with basic tools for installation.

3. The window scoop will provide complete water protection from severe weather, hail, driving rains, etc. Without the use of electricity such as in electric awnings, or shades.

4. The window scoop will provide complete burglar protection for all windows that it is installed on. Without the use of electricity such as in electric alarm systems.

5. The window scoop will eliminate air pollutant such as pollen etc. from penetrating the inside of the house. Do to the 4″ by 30″ air space at the bottom of the window. When driving wind hits the window scoop the air is deflected upward, thus reducing the amount of air and pollents that would normally enter the window with just a screen on it.

6. The window scoop will reduce electric cost if a person chooses to leave his windows open year round, conditions prevailing.

7. The window scoop will reduce outside noises by 50% do to the fact that sound waves can not penetrate the entire window opening section only the area at the bottom of the window thus reducing noise pollution.

8. The window scoop will reduce the inside temperature of the glass by 5% by using tinted Lexan this percentage will increase between 10 to 15%, or greater depending on the direction that the window is facing.

9. The window scoop is maintenance free, and remains transparent. When installed properly can not be detected, only a slight deviation from the normal window view, do to the angle of the bottom of the window having a 4″ thick base.
